(19) United States
(12) Patent Application Publication
(10) Pub. No.: US 2022/0355587 A1
(43) Pub. Date: Nov. 10, 2022

(54) HIGH SCRATCH RESISTANT LAMINATE TUBE WITH METALIZED POLYETHYLENE LAYER DECORATION

(71) Applicant: KIM PACK CO., LTD., Bangkok (TH)

(72) Inventor: Sumet LIMATIBUL, Bangkok (TH)

(73) Assignee: KIM PACK CO., LTD., Bangkok (TH)

(21) Appl. No.: 17/623,518

(22) PCT Filed: Jun. 17, 2020
(86) PCT No.: PCT/TH2020/000040

§ 371 Date: Dec. 28, 2021

(30) Foreign Application Priority Data
Jan. 31, 2020 (TH) 2001000624

(51) Int. Cl. B32B 37/02; B32B 1/08; B32B 7/08; B32B 7/12; B32B 27/08; B32B 27/32; B32B 27/30; B32B 37/15

(52) U.S. Cl. CPC B32B 37/02; B32B 1/08; B32B 7/08; B32B 7/12; B32B 27/08; B32B 27/32; B32B 27/306; B32B 37/153; B32B 2250/242; B32B 2250/44; B32B 2553/00; B32B 2037/246

(57) ABSTRACT

A laminate tube container is made of laminate film or sheet comprising of a vapor metalizing polyethylene film with a vapor evaporated side made of a metal, metal-oxide or inorganic substance, which is adhesive-laminated on the evaporate side with polyethylene film and an adhesive agent then laminated with other extrusion layers of polyethylene, tie and copolymer of ethylene and vinyl alcohol. The laminated tube giving both oxygen and water vapor barrier characteristics making them suitable for packaging tube particularly filled with contents, such as liquid or creamy cosmetic products and toothpastes.

### FIELD OF THE INVENTION

Industrial chemistry relates to a high scratch resistant laminate tube with metallized polyethylene layer decoration.

### BACKGROUND OF THE INVENTION

Aluminium foils have been employed as a barrier in packaging materials for food, personal care, or pharmaceutical products. Packaging tubes with low water vapor transmission rate and low oxygen transmission rate are generally produced by laminating aluminium foil with polyolefin layer on both sides. Delaying the onset oxidative rancidity from visible and UV light is one of the key factors for packaging.

Consumers are more and more emphasis on environmentally friendly production and sustainability when they purchase products. Laminate tubes made from polyolefin and aluminium foil are bringing the difficulty in plastic or aluminium metal's recovery after the end of life usage at the consumers or households by recycling process. The low plastic or metal recovery and the high energy consumption have made them little commercial value, typically using expensive pyrolysis yielded aluminium metal 9% and wastes higher than 70%.

Metalized polyester film has long been used for flexible packaging with moderate gas barrier and high shine. Metalized layers are extremely thin layers of metal deposited on the film as a vapor. Metalized layers are not removed in the recycling process and are melted and blended with the polyester (PET). Since PET and polyethylene (PE) melt at different temperatures, a recycling processor capable of handling PE based film may not be capable of recycling PET based film. Understanding exactly what type of plastic make up your film/sheet will significantly increase your ability to recycle this byproduct. Sustainable packaging is no longer a trend but an expectation of consumers. Lightweight, mono-material, or recyclable materials are counted to innovation. Aluminium vapor metallization on polyethylene films are become interested mainly for recyclability in the common recycling process.

The process of metallization takes place in a vacuum chamber where a metal is melted, evaporated and deposited onto the film's surface. In the case of aluminium, for example, the vapor is deposited on the substrate surface leaving a very thin coat of aluminium metal (e.g. 10-1,000 Angstroms) that is enough to cover the surface pores of the substrate. The deposited metal improves the barrier properties by preventing the transmission rate of oxygen and vapor. Subsequently, the modifications of polymer surface enhance moisture and gas barriers in addition to improve metal adhesion. Direct oxidation of the polymer surface is done either by corona. flame, chemical, or plasma treatment.

Metallized films have been invented for several decades. U.S. Pat. No. 4,357,383 disclosed metallized films comprising a substrate layer of a polymer or copolymer of an alpha-olefin, the molecule of which contains from 2 to 6 carbon atoms, having on at least one surface thereof an adherent layer comprising a random copolymer of ethylene with from 0.5 to 15% by weight, and a metallic layer on the surface of the adherent layer remote from the substrate.

U.S. Pat. No. 5,021,298 disclosed the high barrier metallized film in which comprises of a coated and metallized plastic film. Polyolefin or regenerated cellulose film is coated on one or both surfaces with one or more thin but smooth layers, and metallized over the coated surface or surfaces.

US publication no. 2016/0144603 revealed metallized polyethylene film with improved metal adhesion. A multilayer structure comprises of (a) a skin layer in which at least 50% by weight of an ethylene/α-olefin interpolymer composition (LLDPE); (b) a metal layer disposed on the skin layer to form a metallized film; (c) at least one substrate layer laminated onto the metallized film.

US publication no. 2005/0170161 disclosed metallized packaging films. A metallized layer of thickness 0.02 to 2 microns is provided at least one side of the said core layer and at least 10 to 250 thick food and pharmaceutical grade polymeric layer provided at least on one side of the core layer. A multilayer thermoformable, translucent pharmaceutical and food packaging film consisting the core layer of polyvinyl chloride.

US publication no. 2014/0295118 disclosed the metallized polyethylene laminate comprising an outer polyethylene layer; a metalized acid copolymer layer; an inner polyethylene layer in contact with the metalized acid copolymer layer; and optionally an extruded polyethylene layer; and a sealant layer of polyethylene.

### SUMMARY OF THE INVENTION

The present invention relates to the field of a laminated film or sheet, in particular to a multilayer flexible sheet with high specular gloss providing the aesthetic of high luster and easy to be recyclable in conventional mechanical recycling stream. This invention can be further made for the laminated tube to be used in packaging for food and non-food products.

A laminate-tube container is made of a laminated film or sheet comprising of a vapor-metallized polyethylene film with a metal-evaporated side made of a metal, metal-oxide or inorganic substance, which is adhesive-laminated on the evaporated side with polyethylene film and an adhesive agent then laminated with other extruded layers of polyethylene, tie and copolymer of ethylene and vinyl alcohol. The laminate-tube container gives both oxygen and water-vapor barrier characteristics making them suitable for a packaging tube particularly filled with contents. such as liquid or creamy cosmetic products and toothpastes.

### DETAILED DESCRIPTION

It has now been discovered that a polyethylene-rich laminated structure with 364) degree metallic look can be achieved by the present invention, which provides for methods of preparing a laminated structure with improved recyclability in a mechanical recycling process.

The methods of the present invention provide for the lamination steps starting from preparation of a polyethylene film substrate for metallization with aluminium vapor, and laminating either adhesive or extrusion lamination to provide high bonding strength, high oxygen barrier, scratch resistance, and metallic look.

Suitable linear low-density polyethylene (LLDPE) include copolymers of ethylene and α-olefins. Alpha-olefins include 1-butene, 1-hexene, and 1-octene, and mixtures thereof. LLDPE is commercially available.

Suitable high-density polyethylene (HDPE) include ethylene homopolymer and copolymer of ethylene and α-olefins. Suitable alpha-olefins include 1-butene, 1-hexene, and 1-octene, and mixtures thereof. HDPE is commercially available.

Suitable recycle HDPE or post-consumer HDPE resins should have melt flow rate less than 1 g/10 min for an ease of blending with virgin HDPE resins.

The process of orientation is employed to impart desirable properties to films, including making cast films tougher (higher tensile properties). Depending on whether the film is made by casting as a flat film or by blowing as a tubular film, the orientation process requires substantially different procedures.

Blown films of HDPE resins tend to have greater stiffness and toughness. In contrast, cast films usually have the advantages of greater film clarity and uniformity of thickness and flatness, generally permitting use of a wider range of polymers producing a highly quality film.

Polyethylene films preferably containing HDPE are oriented up to four times in the machine direction to give films having good dead-fold and water-vapor barrier characteristic making them suitable for packaging tube, particularly for further laminated with other polyethylene laver by using adhesive or extrusion lamination.

When the film has been stretched in a single direction (monoaxial orientation), the resulting film exhibits better strength and stiffness along the direction of stretch, but it is weak in other direction, i.e., across the stretch, often splitting or tearing when pulled.

To overcome this limitation, biaxial orientation is employed to more evenly distribute the strength qualities of the film in packaging applications. Most biaxial orientation processes use apparatus that stretches the film sequentially, first in one direction and then in the other. Tenter-frame orienting apparatus stretches the film first in the direction of the film travel, i.e., in the longitudinal or “machine direction”, and then in the direction perpendicular to the machine direction, i.e., the lateral or “transverse direction”. The degree of which a film can be oriented is dependent upon the polymer from which it is made. In the case of HDPE, HDPE exhibits high crystallinity (e.g., about 80-95%) relative to polypropylene (e.g., about 70%). As a result, HDPE films are generally more difficult to biaxially orient than polypropylene films. U.S. Pat. Nos. 4,870,122 and 4,916,025 described imbalanced biaxially oriented HDPE-containing films that are MD oriented up to two times, and TD oriented at least six times.

Metallization is the process to deposit aluminium vapor on film substrate providing shiny and metallic look like a mirror. Regarding to enhance process performance, high barrier metallization for foil replacement and increase shelf life, higher surface energy and better surface energy retention of the vacuum deposited layer as well as high metal adhesion/bond strength are critical requirements. High demand in metal adhesion levels which are greater than 200 g/15 mm, or even up to 600 g/15 mm appeared to be more requested. Most adhesives typically fail around 200-300 g/15 mm in the laminate structure. This is due to the fact that, the single layer metal adhesion frequently measured by seal/peel tests with ethylene acrylic acid (EAA) film, delamination in the laminate structure can take place at the metal-polymer interface at a lower bond strength value than obtained in the EAA peel test. Therefore, the type of laminate structure (duplex/triplex), adhesive as well as the sealant web type and thickness are important and will impact to the failure behavior. Conventional inline plasma pre-treatment can achieve outstanding metal adhesion beyond the levels. Moreover, selecting the technology that involves the deposition of a hybrid coating layer, which has a tailored coating stoichiometry & gradient that exhibits drastically enhanced anchoring properties to the base polymer substrate. Even at very high optical density (OD) levels, where it is typically more difficult to achieve good adhesion levels.

The film substrate for the metallization can be polyolefin, polyester, polypropylene, or polyethylene, however in this case, it is should preferably be polyolefin for further laminating with other layers and made it fully recyclable.

Important embodiments according to this invention are as follows:

(1) A laminate-tube container which made of a laminated film or sheet comprising the laminated layers arranging as follows:

a. a printing layer;

b. an outer polyethylene film layer,

wherein a. and b. can be interchanged;

c. a metallized polyethylene film layer.
wherein said c. metallized polyethylene film layer can be laminated with other layers by

a dry adhesive layer;

d. an intermediate polyethylene film layer;

e. one or more other extruded layers of polyethylene,
wherein when said e. more than one other extruded layers of polyethylene are arranged, they can optionally be additionally interposed by other layers according the following sequence:

f. a first lie layer;

g. an ethylene and vinyl alcohol copolymer barrier layer; and

h. a second tie layer;

and

i. an inner polyethylene film layer.

(2) The laminate-tube container according to item (1) comprising the laminated layers arranging as follows:

a. the printing layer, wherein said a. printing layer is a normal surface printing layer;

b. the outer polyethylene film layer,

c. the metallized polyethylene film layer,
wherein said c. metallized polyethylene film layer can be laminated with other layers by the dry adhesive layer;

d. the intermediate polyethylene film layer;

e. another extruded layer of polyethylene;

and

i. an inner polyethylene film layer.

(3) The laminate-tube container according to claim item (1) comprising the laminated layers arranging as follows:

a. the printing layer, wherein said a. printing layer is a normal surface printing;

b. the outer polyethylene film layer,

c. the metallized polyethylene film layer,
wherein said c. metallized polyethylene film layer can be laminated with other layers by the dry adhesive layer,

d. the intermediate polyethylene film layer;

e. more than one other extruded layers of polyethylene which are additionally interposed by other layers according the following sequence:

f. the first tie layer:

g. the ethylene and vinyl alcohol copolymer barrier layer; and

h. the second tie layer;

and

i. an inner polyethylene film layer.

(4) The laminate-tube container according to claim item (1) comprising the laminated layers arranging as follows:

b. the outer polyethylene film layer,

a. the printing layer, wherein said a. printing layer is a reverse printing;

c. the metallized polyethylene film layer,
wherein said c. metallized polyethylene film layer can be laminated with other layers by the dry adhesive layer;

d. the intermediate polyethylene film layer;

e. another extruded layer of polyethylene;

and

i. an inner polyethylene film layer.

(5) The laminate-tube container according to item (1) comprising the laminated layers arranging as follows:

b. the outer polyethylene film layer,

a. the printing layer, wherein said a. printing layer is a reverse printing;

c. the metallized polyethylene film layer,
wherein said c. metallized polyethylene film layer can be laminated with other layers by the dry adhesive layer;

d. the intermediate polyethylene film layer;

e. more than one other extruded layers of polyethylene which are additionally interposed by other layers according the following sequence:

f. the first tie layer:

g. the ethylene and vinyl alcohol copolymer barrier layer; and

h. the second tie layer;

and

i. an inner polyethylene film layer.

(6) The laminate-tube container according to any one of the preceding items, wherein said film for the metallization can be selected from polyolefin, polyester, polypropylene. or polyethylene, preferably polyolefin.

(7) The laminate-tube container according to item (6), wherein said selected film or sheet can be an unoriented type, a monoaxial oriented type, or a biaxial oriented type, or any combination of two or more thereof.

(8) The laminate-tube container according to items (6) or (7), wherein a skin layer of said film or sheet is pretreated by optionally using corona treatment or plasma treatment prior to the metallization, wherein said metallization can be done by a physical vapor deposition process, wherein in said process, the metal is heated and evaporated under vacuum, and the metal vapor then is condensed on the skin layer of said substrate.

(9) The laminate-tube container according to item (8), wherein said utilized metal includes aluminium, nickel, or chromium.

(10) The laminate-tube container according to any one of the preceding items, wherein said metallized skin layer of the substrate exhibits an optical density of at least 2.0, preferably from 2.0 to 2.8.

(11) The laminate-tube container according to any one of the preceding items, wherein a recycled HDPE resin and a post-consumer HDPE resin can be added in the middle layer of the inner film layer.

(12) The laminate-tube container according to any one of the preceding items, wherein the outer or inner film layer includes a single-layer film: polyolefin.

(13) The laminate-tube container according to any one of the preceding items, wherein the outer or inner film layer includes a three-layer film: polyolefin/HDPE/polyolefin.

(14) The laminate-tube container according to any one of the preceding items, wherein the outer or inner film layer includes a five-layer film: polyolefin/tie/EVOH/tie/polyolefin.

(15) The laminate-tube container according to any one of the preceding items, wherein the outer or inner film layer includes a seven-layer film: polyolefin/HDPE/tie/EVOH/tie/HDPE/polyolefin.

(16) The laminate-tube container according to any one of the preceding items, wherein the barrier layer is formed of an ethylene and vinyl alcohol copolymer (EVOH) and its derivatives.

(17) The laminate-tube container according to item (16), wherein said barrier layer is used as a barrier to oxygen, and an ethylene content in the EVOH resin is 32-44%. preferably 35% or lower in order to provide sufficient oxygen barrier to the laminate tube.

(18) The laminate-tube container according to any one of the preceding items, wherein said another extruded layer of polyethylene has a total thickness of 158-645 microns.

(19) The laminate-tube container according to any one of the preceding items, wherein said more than one other extruded layers of polyethylene have a total thickness of 130-455 microns.

(20) The laminate-tube container which made of the laminated film or sheet according to any one of the preceding items, wherein said laminate-tube container is used in packaging for food and non-food products.

(21) The laminate-tube container which made of the laminated film or sheet according to any one of the preceding items, wherein said laminate-tube container is used in packaging for liquid or creamy cosmetic products.

(22) The laminate-tube container according to any one of the preceding items, wherein said laminate-tube container has 360-degree metallic look.

(23) The laminate-tube container according to any one of the preceding items, wherein the laminate-tube container has improved recyclability in a mechanical recycling process.

(24) A method for producing the laminate-tube container which made of the laminated film or sheet comprising the laminated layers arranging according to item (1), comprising following steps of:
preparing the printing layer for laminating on the laminate-tube container;
subjecting the polyethylene film to metal evaporation on one side;
then performing adhesive-lamination with the intermediate polyethylene film layer and the outer polyethylene film layer by using an adhesive agent;
next the laminated film is further laminated with the inner polyethylene film layer by using extrusion lamination with hot-melted resins of LLDPE which optionally has the tie and the ethylene vinyl alcohol (EVOH),

wherein, said method provides the laminate-tube container having a total thickness of 158-645 microns.

(25) A method for producing the laminate-tube container which made of the laminated film or sheet comprising laminated layers arranging according to item (1), comprising steps of:
preparing the printing layer for laminating on the laminate-tube container;
subjecting the polyethylene film layer to metal evaporation on one side;
then performing adhesive-lamination with the intermediate polyethylene film and the outer polyethylene film with the reverse printing by using an adhesive agent;
next the laminated film is further laminated with the inner polyethylene film by using extrusion lamination with hot-melted resins of LLDPE,

wherein, said method provides the laminate-tube container having a total thickness of 130-455 microns.

(26) The method for producing the laminate-tube container according to items (24) or (25), wherein said printing layer for laminating on the prepared laminate-tube container optionally can be a normal surface printing or a reverse printing.

(27) The laminate-tube container which made of the laminated film or sheet according to the method of any one of the preceding items, wherein said laminate-tube container is used in packaging for food and non-food products.

(28) The laminate-tube container which made of the laminated film or sheet according to item (25), wherein said laminate-tube container is used in packaging for liquid or creamy cosmetic products.

(29) The laminate-tube container which made of the laminated film or sheet according to the method of any one of the preceding items, wherein said laminate-tube container has 360-degree metallic look.

(30) The laminate-tube container which made of the laminated film or sheet according to the method of any one of the preceding items, wherein the laminate-tube container has improved recyclability in a mechanical recycling process.

Outer Layer

Coextrusion blown film with at least three-layer are used for providing good tensile strength and puncture resistance. In the embodiments, optionally selected mono-layer, three layers. seven layers or multilayered film. In the embodiments, the multilayered film comprises of one or more polymeric materials such as low-density polyethylene, linear low-density polyethylene, high density polyethylene, copolymer of ethylene and propylene. A recycled HDPE resin and a post-consumer HDPE resin should be added in the middle layer of the inner film layer. The recycled content should not be as high as lowering the mechanical properties of the outer layer.

One embodiment of the invention is a single-layer film: polyolefin.

One embodiment of the invention is a three-layer film: polyolefin/HDPE/polyolefin.

One embodiment of the invention is a five-layer film: polyolefin/tie/EVOH/tie/polyolefin.

One embodiment of the invention is a seven-layer film: polyolefin/HDPE/tie/EVOH/tie/HDPE/polyolefin.

Outer Polyethylene film of the invention is characterized as follows:
Optionally, mono-layered, three-layered film, five-layered film or multilayered film
Optionally, unoriented polyethylene film, machine-direction orientation (MDO) film, or biaxial-oriented PE (BOPE) film
Optionally, homopolymer or copolymer polyolefins, e.g. VLDPE, LDPE, LLDPE, MDPE, HDPE, recycled HDPE, post-consumer HDPE, PP homopolymer, PP copolymer, copolymer of ethylene and propylene and mixture thereof
Outer layer should have high clarity grade of polyolefin resins such as metallocene polyethylene family
Optionally, manufacturing process by extrusion process, e.g. blown or cast film lines
Optionally, extension unit after extrusion lines in order to provide film with high stiffness, toughness, good tensile strength at break for better impact resistance during printing process. Examples of an extension units are machine-direction orientation film stretching unit, biaxially-oriented direction film stretching unit
Outer layer should have total haze of Outer Polyethylene film should be <10%
In case of multilayered film, when the number of layers is greater than 3 layers, additional barrier resin can be added in the film such as five-layered blown film of PE/Tie/EVOH/Tie/PE, seven-layered blown film of PE/Tie-Nylon/EVOH/Nylon/Tie/PE
Optionally, outer Polyethylene film is suitable for surface printing such as flexo printing, letterpress printing, offset printing, etc.
Optionally, outer Polyethylene film is suitable for reverse printing such as rotogravure
In case of rotogravure printing, film substrate should have 0-7% shrinkage under 105° C. for 5 min in order to provide film tolerance to the high web tension
thickness 30-60 microns

### Metalized Substrate

The substrate may comprise any one or more polyolefin materials suitable for use in a multilayer structure. Such materials include, for example a multilayer blown or cast film with unoriented, monoaxial oriented, or biaxial oriented polyolefins, or any combination of two or more thereof. A five-layered blown film of PE/Adhesive/EVOH/Adhesive/PE can be used for enhancing the protection of the metallic layer from delamination by absorption of substances in the filled products.

The metallization on the top surface of the substrate (skin layer) may be accomplished using an appropriate technique. In the embodiments, the skin layer of the substrate is pretreated, such as corona treatment or plasma treatment, prior to the metallization. The Metallization may be done by a physical vapor deposition process. In such process, the metal is heated and evaporated under vacuum. The metal vapor then is condensed on the skin layer of the substrate.

In some embodiments, the resulting metallized skin layer exhibits an optical density of at least 2.0. The optical density of the metallized skin layer may be from 2.0 to 2.8. Any appropriate metal can be used, depending on the final application used for the multilayered film/sheet. The commonly used metals include aluminium, nickel, or chromium.

A recycled HDPE resin and a post-consumer HDPE resin should be added in the middle layer of the inner film layer.

Metallized substrate of the invention is characterized as follows:
Optionally, unoriented polyethylene film, machine-direction orientation (MDO) film, or biaxial-oriented PE (BOPE) film
Optionally, mono-layered, three-layered film, five-layered film or multilayered film
Optionally, homopolymer or copolymer polyolefins, e.g. VLDPE, LDPE. LLDPE, MDPE, HDPE, recycled HDPE, post-consumer HDPE, PP homopolymer, PP copolymer, copolymer of ethylene and propylene and mixture thereof
Metallized substrate should have high clarity grade of polyolefin resins such as metallocene polyethylene family
Optionally, manufacturing process by extrusion process, e.g. blown or cast film lines
Optionally, extension unit after extrusion lines in order to provide film with high stiffness, toughness, good tensile strength at break for better impact resistance during printing process. Examples of an extension units are machine-direction orientation film stretching unit, biaxially-oriented direction film stretching unit
Optionally, total haze of Outer Polyethylene film should be <10%
In case of multilayered film, when the number of layers is greater than 3 layers, additional barrier resin can be added in the film such as five-layered blown film of PE/Tie/EVOH/Tie/PE, seven-layered blown film of PE/Tie/Nylon/EVOH/Nylon/Tie/PE
Optionally, metals are made of metals, metal-oxides or inorganic substances e.g. Aluminium, Copper
Optionally, vacuum metallizer is used for metal deposition on film
Optionally, ion bombardment of metal on film substrates is done either evaporation or sputtering
Metallized substrate should have optical density of metalized film can be 1.5-3
Metallized substrate should have the adhesion strength to metal of metallized film can be >200 gf/15 mm
Metallized substrate should have gloss value of metalized film is greater than 800 under 20°
Metallized substrate should have thickness 12-110 microns

Tie Resins

Tie resins are selected based on the layers being bonded, the melt index, process conditions, secondary operations (e.g. orientation) and the cost. The melt index should be selected so that the layers in contact have similar viscosities; otherwise the flow instabilities can lead to waviness or poor layer distribution. Generally, the interior layer should have the highest viscosity while the outer or skin layer should have the lowest viscosity. A suitable tie-layer adhesive is maleic-anhydride grafted polyolefins or derivatives thereof.

Tie resin of the invention is characterized as follows:
Optionally, two-component polyurethane such as aromatic or aliphatic polyester of diol and diisocyanate
Optionally, solvent-based type
Tie resins should have thickness 0.1-5 microns or 0.1-5 g/m², typically 3-5 g/m²

Intermediate Polyethylene Film

Intermediate polyethylene film of the invention is characterized as follows:
Optionally, mono-layered, three-layered film, five-layered film or multilayered film
Optionally, homopolymer or copolymer polyolefins, e.g. VLDPE, LDPE, LLDPE, HDPE, recycled HDPE, post-consumer HDPE. PP homopolymer, PP copolymer, copolymer of ethylene and propylene and mixture thereof
Optionally, manufacturing process by extrusion process, e.g. blown or cast film lines
Inner film should have good heat seal properties
Intermediate polyethylene should have thickness 40-120 microns

LLDPE Extrusion Layer

LLDPE extrusion layer of the invention is characterized as follows:
Optionally, LLDPE density 0.903-0.945 g/cc
Optionally, LLDPE extrusion resin grade
LLDPE extrusion layer should have thickness 7-50 microns

Tie Extrusion Layer

Tie extrusion layer of the invention is characterized as follows:
Optionally, an anhydride-modified, low-density polyethylene resins containing end group anhydride
Optionally, solvent less type
Tie extrusion layer has thickness 7-50 microns

Barrier Layer

An ethylene-vinyl alcohol copolymer (EVOH) and its derivatives are employed as a barrier to oxygen. An ethylene content in the EVOH resin should be lower than 35% in order to provide sufficient oxygen barrier to the laminate tube.

Barrier of the invention is characterized as follows:
Optionally, copolymer of ethylene and vinyl alcohol with ethylene content 35% or lower
Optionally, copolymer of nylon e.g. amorphous, semi-crystalline type
Barrier layer should have thickness 7-50 microns

Inner Layer

Coextrusion blown film with at least three-layer are used for providing good tensile strength and puncture resistance. In the embodiments, optionally selected mono-layer, three layers, seven layers or multilayered film. In the embodiments, the multilayered film comprises of one or more polymeric materials such as low-density polyethylene, linear low-density polyethylene, high density polyethylene, copolymer of ethylene and propylene. A recycled HDPE resin and a post-consumer HDPE resin should be added in the middle layer of the inner film layer.

One embodiment of the invention is a single-layer film: polyolefin.

One embodiment of the invention is a three-layer film: polyolefin/HDPE/polyolefin.

One embodiment of the invention is a five-layer film: polyolefin/tie/EVOH/tie/polyolefin.

One embodiment of the invention is a seven-layer film: polyolefin/HDPE/tie-EVOH/tie/HDPE % polyolefin.

Inner film of the invention is characterized as follows:
Optionally, mono-layered, three-layered film, five-layered film or multilayered film
Optionally, homopolymer or copolymer polyolefins, e.g. VLDPE, LDPE, LLDPE, HDPE, recycled HDPE, post-consumer HDPE, PP homopolymer, PP copolymer, copolymer of ethylene and propylene or mixture thereof
Optionally, manufacturing process by extrusion process, e.g. blown or cast film lines
Inner film should have good heat seal properties
Inner film should have thickness 40-120 microns

In one embodiment of the invention is provided a method for producing the laminate-tube container which made of the laminated film or sheet comprising the laminated layers arranging according to the invention, comprising following steps of:
subjecting the polyethylene film to metal evaporation on one side;
then performing adhesive-lamination with the intermediate polyethylene film layer and the outer polyethylene film layer by using an adhesive agent;
next the laminated film is further laminated with the inner polyethylene film layer by using extrusion lamination with hot-melted resins of LLDPE which optionally has the tie and the ethylene vinyl alcohol (EVOH),
printing on the surface with a normal printing

wherein, said method provides the laminate-tube container having a total thickness of 158-645 microns.

Other embodiment of the invention is provided a method for producing the laminate-tube container which made of the laminated film or sheet comprising laminated layers arranging according to the invention, comprising following steps of:
reverse printing is normally gravure printing;
subjecting the polyethylene film layer to metal evaporation on one side;
then performing adhesive-lamination with the intermediate polyethylene film and the outer polyethylene film with the reverse printing by using an adhesive agent;
next performing lamination on the resulting laminated film with the inner polyethylene film by using extrusion lamination with hot-melted resins of LLDPE,

wherein said method provides the laminate-tube container having a total thickness of 130-455 microns.

According to the above mentioned methods of the invention are provided a laminate-tube container which made of the laminate-tube container is used in packaging for food and non-food products.

Furthermore, the laminate-tube container which made of the laminated film or sheet according to the invention is the laminate-tube container is used in packing of liquid or creamy cosmetic products.

### Examples

The following pan explains the invention in details using examples, but the invention is not to be considered limited to what is shown in these examples.

Inventive multi-layered structure film/sheet Example 1 (KPL-06EV15): Surface printing/Outer PE Film55/dry adhesive5/mLLDPE film 90/dry adhesive3/LLDPE film 40/LLDPE extrusion22.5/Tie15/EVOH15/Tie15/LLDPE extrusion22.5/inner PE Film100

A polyethylene film with the thickness of 90 micron evaporated on one side with metal is adhesive-laminated with intermediate polyethylene film (40 micron) and outer polyethylene film (55 micron) by using an adhesive agent. Next, this laminate film is further laminated with inner polyethylene film (100 micron) by using extrusion lamination with hot-melted resins of LLDPE, tie, and ethylene vinyl alcohol (EVOH). Surface printing can be any one of the conventional printings such as letterpress, UV dry-offset, flexo printing, screen printing, digital printing and the like with a total thickness of 158-645 microns.

Inventive multi-layered structure film/sheet Example 2: Outer LLDPE Film 55/Reverse printing/dry adhesive5/mLLDPE film90/dry adhesive3/LLDPE film 50/LLDPE extrusion 60/Inner LLDPE Film 120

Reverse printing is generally a gravure printing. A polyethylene film with the thickness of 90 micron evaporated on one side with metal is adhesive-laminated with intermediate polyethylene film (50 micron) and outer polyethylene film with reverse printing (55 micron) by using an adhesive agent of 5 g/m². Next, this laminate film is further laminated with inner polyethylene film (100 micron) by using extrusion lamination with hot-melted resins of LLDPE with a total thickness of 130-455 microns.

Comparative multi-layered structure film/sheet Example 3: Outer PE Film45/mPET12/PE Film60/LLDPE30/Tie15/EVOH20/Tie15/LLDPE30/Inner PE Film100

This is a comparative Example not according to this invention. A polyester film with the thickness of 12 micron evaporated on one side with metal is adhesive-laminated with polyethylene film (60 micron) and outer polyethylene film (45 micron) by using an adhesive agent. Next, this laminate film is further laminated with inner polyethylene film (100 micron) by using extrusion lamination with hot-melted resins of LLDPE, tie, and ethylene vinyl alcohol (EVOH).

Test Methods

Barrier Properties

The conditions for determining Water Vapor Transmission Rate (WVTR) of laminated film/sheet according to ASTM F1249-06 were as followed: temperature 38° C., relative humidity 90%, sample size 10 cm², and carrier gas is N₂.

The conditions for determining Oxygen Transmission Rate (OTR) of laminated film/sheet according to ASTM D3985-05 were as followed: temperature 23° C., relative humidity 0%, sample size 100 cm², and carrier gas is N₂.

The conditions for determining Water Vapor Transmission Rate (WVTR) of laminated tube package according to ASTM WK49124 were as followed: temperature 38° C., relative humidity 90%, and carrier gas is N₂.

The conditions for determining Oxygen Transmission Rate (OTR) of laminated tube package according to ASTM F1307-02 were as followed: temperature 25° C., relative humidity 60%, and carrier gas is N₂.

Bond Strength

Sample preparation and measurements were performed according to the following methods: (1) Cut one-inch sample strip from the laminate to be tested. Samples can be cut from any direction; (2) There will need to be delaminate tabs for each two substrates long enough to fit between the jaws of the tensile tester such that the tester will read zero at the beginning of the test. The start of the laminated area should be perpendicular to the direction of the tab which is also referred to “T-peel” using a cross head speed of 80 mm/min.; (3) Place the sample in the jaws of the zero tensile tester; (4) Record the bond strength value and the mode of failure.

Gloss

Gloss value is measured to determine the luster effect on the top surface of the laminate tube without printing artwork by ASTM D2457-08 (angle 20°) using Elcometer 407L.

Compression Test Using the General Single-Column Force Tester

50 mm Diameter laminate tube is placed below the wire frame probe with the dimensions of 3 mm width×10 mm high×125 mm long (deep). The initial position is set at 75 mm height. The crosshead speed is set at 50 mm/min and press the tube for 30 mm. The measurement is the maximum in the load vs displacement curve and convert to the stiffness value (gram force).

Scratch Resistance

The drop of the liquid bulk product is put on the printing surface of tube. After leaving the sample for 24 hours, using one soft paper tissue per drop and wipe the product off the printing surface. Examining the printing surface and the paper tissue for traces of ink bleed, metallic look blocking and grade samples as No change, Noticeable. Bad.

Table 1 showed the oxygen and water vapor barrier properties of the present invention. Water vapor barrier depends on the barrier resin and the total thickness of laminate structure. When the total thickness of polyethylene laminate with barrier EVOH increases, the water vapor barrier increases. In the present invention, when the EVOH thickness is increased from 15 to 25 micron, the oxygen barrier did not significantly increase. The present invention provided the competitive barrier value compared to the comparative example.

TABLE 1
Barrier properties of the inventive example 1 with different thickness.

| | | Total thickness | OTR | | WVTR | |
|---|---|---|---|---|---|---|
| Sample | | (micron) | cc/m² · day | cc/pkg · day | g/m² · day | g/pkg · day |
| 1 | KP-01EV15 | 250 | 2.21 | 5.46 | 0.94 | 0.025 |
| 2 | KP-02EV15 | 275 | 1.92 | 5.14 | 0.70 | 0.012 |
| 3 | KP-03EV15 | 300 | 0.97 | 3.82 | 0.69 | 0.021 |
| 4 | KP-04EV25 | 300 | 0.82 | 2.82 | 0.73 | 0.022 |
| 5 | KP-05EV15 | 350 | 0.86 | N/A | 0.62 | N/A |
| 6 | KP-06EV15 | 380 | 2.02 | N/A | 0.51 | N/A |
| 7 | Comparative | 380 | 2.24 | N/A | 0.27 | N/A |
| | example | | | | | |

A metallized polyester film has a shiny effect with approximately gloss value >1,000 GU as shown in Table 2. However, KP-06EV15 had a lower gloss value (>600 GU). This might be due to the roughness of the polyethylene nature compared to polyester film. The fabrication process to produce very smooth surface of the substrate film might be the major factor for giving the higher gloss value. Oriented film monoaxially or biaxially can be a factor to stretch and yielding the smooth surface compared to unoriented film. Unsurprisingly, the boding strength of the outer polyethylene film and the metalized polyethylene film are stronger than that and polyester film. High bonding strength can be achieved inherently by using metalized laminate tube in this invention. The present tube invention gives soft and squeezable (<630) in comparison with polyester film in the laminate tube (>690).

Moreover, the scratch resistance of laminate tube in this invention can be vey high to the metallic peel-off issue. This metalized polyethylene laminate tube allows much better scratch resistance than hot foil stamping or cold for transfer on the printing surface of laminate tube.

TABLE 2
Bonding strength, gloss, compression test of inventive example 1.

| | | Total | Bonding | Gloss | Compression |
|---|---|---|---|---|---|
| | | thickness | strength | 20° | test on tube |
| Sample | | (micron) | (g/15 mm) | (GU) | (gf) |
| 1 | KP-06EV15 | 380 | >800 | >600 | <630 |
| | | | (outer film// | | |
| | | | metalized | | |
| | | | polyethylene | | |
| | | | layer) | | |
| 2 | Comparative | 380 | >500 | >1,000 | >690 |
| | example | | (outer film// | | |
| | | | metalized | | |
| | | | polyester | | |
| | | | layer) | | |

As stated above, it is showed that the invention can be provided a laminate-tube container which is characterized in that a laminate tube container is made of laminate film or sheet comprising of a vapor metalizing polyethylene film with a vapor evaporated side made of a metal, metal-oxide or inorganic substance, which is adhesive-laminated on the evaporate side with polyethylene film and an adhesive agent then laminated with other extrusion layers of polyethylene, tie and copolymer of ethylene and vinyl alcohol. The laminated tube giving both oxygen and water vapor barrier characteristics which suitable for noticeable to the consumer making them suitable for packaging tube particularly filled with contents, such as liquid or creamy cosmetic products including toothpastes.

1. A laminate-tube container which made of a laminated film or sheet comprising the laminated layers arranging as follows:
a. a printing layer;
b. an outer polyethylene film layer,
wherein a. and b. can be interchanged;
c. a metallized polyethylene film layer,
wherein said c. metallized polyethylene film layer can be laminated with other layers by a dry adhesive layer:
d. an intermediate polyethylene film layer;
e. one or more other extruded layers of polyethylene,
wherein when said e. more than one other extruded layers of polyethylene are arranged, they can optionally be additionally interposed by other layers according the following sequence:
f. a first tie layer;
g. a barrier layer; and
h. a second tie layer;
and
i. an inner polyethylene film layer.

2. The laminate-tube container according to claim 1 comprising the laminated layers arranging as follows:
a. the printing layer, wherein said a. printing layer is a normal surface printing;
b. the outer polyethylene film layer,
c. the metallized polyethylene film layer,
wherein said c. metallized polyethylene film layer can be laminated with other layers by the dry adhesive layer;
d. the intermediate polyethylene film layer;
e. another extruded layer of polyethylene;
and
i. an inner polyethylene film layer.

3. The laminate-tube container according to claim 1 comprising the laminated layers arranging as follows:
a. the printing layer, wherein said a. printing layer is a normal surface printing;
b. the outer polyethylene film layer,
c. the metallized polyethylene film layer,
wherein said c. metallized polyethylene film layer can be laminated with other layers by the dry adhesive layer;
d. the intermediate polyethylene film layer;
e. more than one other extruded layers of polyethylene which are additionally interposed by other layers according the following sequence:
f. the first tie layer;
g. the barrier layer; and
h. the second tie layer;
and
i. an inner polyethylene film layer.

4. The laminate-tube container according to claim 1 comprising the laminated layers arranging as follows:
b. the outer polyethylene film layer,
a. the printing layer, wherein said a. printing layer is a reverse printing;
c. the metallized polyethylene film layer,
wherein said c. metallized polyethylene film layer can be laminated with other layers by the dry adhesive layer;
d. the intermediate polyethylene film layer;
e. another extruded layer of polyethylene; and
i. an inner polyethylene film layer.

5. The laminate-tube container according to claim 1 comprising the laminated layers arranging as follows:
b. the outer polyethylene film layer,
a. the printing layer, wherein said a. printing layer is a reverse printing;
c. the metallized polyethylene film layer,
wherein said c. metallized polyethylene film layer can be laminated with other layers by the dry adhesive layer;
d. the intermediate polyethylene film layer;
e. more than one other extruded layers of polyethylene which are additionally interposed by other layers according the following sequence:
f. the first tie layer;
g. the barrier layer; and
h. the second tie layer;
and
i. an inner polyethylene film layer.

6. The laminate-tube container according to claim 1, wherein said film for said metallization can be selected from polyolefin, polyester, polypropylene, or polyethylene, preferably polyolefin.

7. The laminate-tube container according to claim 6, wherein said selected film or sheet can be an unoriented type, a monoaxial oriented type. or a biaxial oriented type, or any combination of two or more thereof.

8. The laminate-tube container according to claim 6, wherein a skin layer of said substrate is pretreated by optionally using corona treatment or plasma treatment prior to the metallization, wherein said metallization can be done by a physical vapor deposition process, wherein in said process, the metal is heated and evaporated under vacuum, and the metal vapor then is condensed on the skin layer of said substrate.

9. The laminate-tube container according to claim 8, wherein said utilized metal includes aluminium, nickel, or chromium.

10. The laminate-tube container according to claim 1, wherein said metallized skin layer of the substrate exhibits an optical density of at least 2.0, preferably from 2.0 to 2.8.

11. The laminate-tube container according to claim 1, wherein a recycled HDPE resin and a post-consumer HDPE resin can be added in the middle layer of the inner film layer.

12. The laminate-tube container according to claim 1, wherein the outer or inner film layer includes a single-layer film: polyolefin.

13. The laminate-tube container according to claim 1, wherein the outer or inner film layer includes a three-layer film: polyolefin/HDPE/polyolefin.

14. The laminate-tube container according to claim 1, wherein the outer or inner film layer includes a five-layer film: polyolefin/tie/EVOH/tie/polyolefin.

15. The laminate-tube container according to claim 1, wherein the outer or inner film layer includes a seven-layer film: polyolefin/HDPE/tie/EVOH/tie/HDPE/polyolefin.

16. The laminate-tube container according to claim 1, wherein the barrier layer is formed of an ethylene and vinyl alcohol copolymer (EVOH) and its derivatives.

17. The laminate-tube container according to claim 16, wherein said barrier layer is used as a barrier to oxygen, and an ethylene content in the EVOH resin is 32-44%, preferably 35% or lower in order to provide sufficient oxygen barrier to the laminate tube.

18. The laminate-tube container according to claim 1, wherein said another extruded layer of polyethylene has a total thickness of 158-645 microns.

19. The laminate-tube container according to claim 1, wherein said more than one other extruded layers of polyethylene have a total thickness of 130-455 microns.

20. The laminate-tube container which made of the laminated film or sheet according to claim 1, wherein said laminate-tube container is used in packaging for food and non-food products.

21. The laminate-tube container which made of the laminated film or sheet according to claim 1, wherein said laminate-tube container is used in packaging for liquid or creamy cosmetic products.

22. The laminate-tube container according to claim 1, wherein said laminate-tube container has 360-degree metallic look.

23. The laminate-tube container according to claim 1, wherein the laminate-tube container has improved recyclability in a mechanical recycling process.

24. A method for producing the laminate-tube container which made of the laminated film or sheet comprising the laminated layers arranging according to claim 1, comprising following steps of:
preparing the printing layer for laminating on the laminate-tube container,
subjecting the polyethylene film to metal evaporation on one side;
then performing adhesive-lamination with the intermediate polyethylene film layer and the outer polyethylene film layer by using an adhesive agent;
next performing lamination on the resulting laminated film with the inner polyethylene film layer by using extrusion lamination with hot-melted resins of LLDPE which optionally has the tie and the ethylene vinyl alcohol (EVOH),
wherein, said method provides the laminate-tube container having a total thickness of 158-645 microns.

25. A method for producing the laminate-tube container which made of the laminated film or sheet comprising laminated layers arranging according to claim 1, comprising steps of:
preparing the printing layer for laminating on the laminate-tube container;
subjecting the polyethylene film to metal evaporation on one side;
then performing adhesive-lamination with the intermediate polyethylene film layer and the outer polyethylene film layer with the reverse printing layer by using an adhesive agent;
next the laminated film is further laminated with the inner polyethylene film layer by using extrusion lamination with hot-melted resins of LLDPE,
wherein, said method provides the laminate-tube container having a total thickness of 130-455 microns.

26. The method for producing the laminate-tube container according to claim 24, wherein said printing layer for laminating on the prepared laminate-tube container optionally can be a normal surface printing or a reverse printing.

27. The laminate-tube container which made of the laminated film or sheet according to the method of claim 24, wherein said laminate-tube container is used in packaging for food and non-food products.

28. The laminate-tube container which made of the laminated film or sheet according to the method of claim 27, wherein said laminate-tube container is used in packaging for liquid or creamy cosmetic products.

29. The laminate-tube container which made of the laminated film or sheet according to the method of claim 24, wherein said laminate-tube container has 360-degree metallic look.

30. The laminate-tube container which made of the laminated film or sheet according to the method of claim 24, wherein the laminate-tube container has improved recyclability in a mechanical recycling process.
